(19) United States
(12) Patent Application Publication
(10) Pub. No.: US 2008/0270191 A1
(43) Pub. Date: Oct. 30, 2008

(54) MEDICAL DATA STORAGE METHOD AND SYSTEM

(76) Inventors: Peter Neil Beeckel, Turner, ME (US); Michael Alan Bergeron, Durham, ME (US)

Correspondence Address: HOWARD M COHN;PATENT ATTORNEY LLC, 21625 CHAGRIN BLVD #220, CLEVELAND, OH, 44122, US

(21) Appl. No.: 12/111,165

(22) Filed: Apr. 29, 2008

Related U.S. Application Data
(60) Provisional application No. 60/914,349, filed on Apr. 27, 2007.

(51) Int. Cl. G06Q 50/00; G06F 17/30

(52) U.S. Cl. 705/3

(57) ABSTRACT

A method and system for medical data storage is disclosed. The method and system include receiving patient identifying data, validating patient identifying data, loading a patient record, displaying symptom query interface, receiving patient data as to symptoms, displaying updated symptom interface and storing data about patients.

### CROSS-REFERENCE TO RELATED APPLICATIONS

This application claims priority to U.S. Provisional Patent Application Ser. No. 60/914,349, entitled “ASAP Medical Software”, filed Apr. 27, 2007, the disclosure of which is hereby expressly incorporated herein by reference.

### TECHNICAL FIELD OF THE INVENTION

The present invention relates generally to a medical software system for managing a health care center, and more particularly to a medical software system adapted to efficiently gather and store all of the pertinent records for a patient of a health care center.

### BACKGROUND OF THE INVENTION

Hand-written patient record-keeping systems have evolved through many years of careful refinement and enhancement into systems which maintain a detailed manual record of medical information concerning each patient. To meet the needs of different hospital entities (such as for example, doctors, nurses, pharmacy, accounting, and laboratories) requiring access to such medical information, a manual record-keeping system of various medical information is logged into multiple types of records.

A patient entering a clinic may be admitted by a registration department or though an emergency care unit and assigned a room in an out-patient clinic. Later, the admitted patient may undergo a series of tests that involve the clinic's laboratories and specimens may be taken to determine the state of the patient's health. The patient may then, depending on the results of the tests, undergo treatment under care of physicians, medical care providers and/or nursing staff. A constant running medical record is taken throughout the patient's stay. There is also a record of accounting and the administered and required medications. There is a need for a way to efficiently gather and store all of the pertinent records for a patient and to allow all of those involved with the patient access to the records immediately, while still maintaining the patient's confidentiality.

Additionally, a patient requiring medical attention can begin the process of seeking care by presenting personally to an out-patient clinic generally without any knowledge of that particular clinic's current level of activity or any information regarding the amount of time that will be required before being evaluated. There is a need for a way to efficiently process information regarding the level of activity of an outpatient clinic in real time and efficiently convey that information: (1) to potential patients so that they may make informed decisions regarding when and where to present themselves to an outpatient clinic for evaluation, as well as: (2) to current patients so that they can be accurately informed regarding what to expect for wait time prior to evaluation.

When a patient requires evaluation and care for an acute illness, the standard of care is for the patient to present personally at an outpatient clinic and wait in line to register at a registration window where an administrative assistant collects registration information, including demographic, financial and clinical data, and record this information into an electronic database or onto a handwritten document. This labor intensive process adds significant time, labor and expense onto the medical evaluation and treatment process. There is a need for a way to efficiently collect and process registration and intake information from the presenting patient in a way that is more time and cost efficient and less labor intensive.

The current standard of data collection as outlined above occurs immediately before and during the time of the evaluation and treatment of the patient. The additional time required for this process to occur creates a number of undesirable consequences. The registration area and, as a direct effect, the waiting area of the clinic both become filled with patients waiting for evaluation and treatment. This “bottleneck” commonly adds significant time, potentially hours, to the process of evaluation and treatment in the clinic. Because this information can only be collected at the time of the onset of the evaluation and treatment process, a potential patient must expect to utilize significantly more time for the entire process than is actually taken for the specific portion that is clinical evaluation and treatment. This current process also creates a situation that cohorts a group of people with varying degrees of illness together with their non-ill companions, in a small area for an extended period of time. The length of time in contact with illness increases the likelihood of transmission of disease from one person to another. Many times a parent will be accompanied by children. This additional wait deprives a patient and their accompanying companions of time that could or should be spent in more productive activities including work, child care and other responsibilities. There is a need for a way to efficiently reduce the amount of time required for a patient to be personally in the clinic for the “non-clinical” portion of a clinical visit by increasing the time efficiencies of the in-situ registration process as well as creating alternatives to the standard “in-person” registration process.

There is also a need to improve the general health risks of persons waiting for medical evaluation and treatment for acute illness. There is also a great need include the consideration of conveniences to the patient in seeking acute medical care.

### SUMMARY OF THE INVENTION

According to the present invention, there is disclosed a method for medical data storage. The method includes the steps of receiving patient identifying data;

validating patient identifying data; loading a patient record; displaying symptom query interface; receiving patient data as to symptoms; displaying updated symptom interface; and storing data about patient.

Further according to the present invention, the step of loading a record includes the step of searching for prior patient records and updating the patient record with any prior patient records.

Still further according to the present invention, there are additional steps of generating a patient consent form; and storing said patient consent form after it has been authorized by the patient.

Yet further according to the present invention, the method includes the steps of placing patient into patient queue based on patient queue criteria. Placing the patient into patient queue can based on a patient queue criteria of when the patient authorizes the consent form. Placing the patient into patient queue can based on a patient queue criteria of the symptoms presented. Placing the patient into patient queue can based on a patient queue criteria selected from the group of when the patient authorizes the consent form the symptoms presented.

Also according to the present invention, the method includes the step of creating alerts based on high-risk symptoms.

Further according to the present invention, the method includes the step of validating patient identifying data to correlate with insurance.

Yet further according to the present invention, the method includes the step of generating a patient history that may be viewed on an interface.

Still further according to the present invention, the method includes the step of updating patient file history by an onsite care provider.

Further according to the present invention, the method includes the step of creating a patient follow-up communication selected from a group consisting of ordering a lab test, generating a prescription, generating a patient instruction sheet, generating an insurance claim, generating a patient bill.

Also according to the present invention, the method includes the step of updating a patient record to reflect an action consisting of a filling a prescription, filing a consent, authorizing medical treatment, making payment and declining medical treatment.

According to the present invention, there is disclosed a system for medical data storage comprising a receiving interface capable of receiving patent data; a database capable of storing and retrieving stored patient data; and a communication interface capable providing a communication selected from a group consisting of a prescription, a medical directive, a bill, a queue position to see a care provider.

Further according to the present invention, the system includes a care provider interface.

Also according to the present invention, the system includes at least one distributed network component for communicating patient data selected from the group including a pharmacy database, an insurance company data base, A HIPPA compliant patient record database, a non-Hippa complaint patient database, a research data base, a proximate health care provider interface, a remoter health care provider interface, a searchable data base, and a redundant back-up data base.

According to the present invention, the system includes a device for generating reports from the group including a printer, data bases and storage discs.

According to the present invention, there is disclosed an article comprising a machine readable medium having embodied thereon a program, the program being executable by a machine to process patients who visit a health clinic for medical attention by performing receiving patient identifying data; validating patient identifying data; loading a patient record; displaying symptom query interface; receiving patient data as to symptoms; displaying updated symptom interface; and storing data about patient.

Also according to the present invention, there is disclosed an article which further includes placing the patients into patient queue based on patient queue criteria.

Further according to the present invention, there is disclosed an article which includes searching for prior patient records and updating the patient record with any prior patient records.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity.

In the drawings accompanying the description that follows, both reference numerals and legends (labels, text descriptions) may be used to identify elements.

If legends are provided, they are intended merely as an aid to the reader, and should not in any way be interpreted as limiting.

FIG. 1 is a flow chart of a series of steps, in accordance with the present invention.

FIG. 2 is a flow chart of the method for medical data storage, in accordance with the present invention.

FIG. 3 is a flow chart of the method for medical data storage, in accordance with the present invention.

FIG. 4 is a system for medical data storage, in accordance with the present invention.

### DETAILED DESCRIPTION OF EXEMPLARY EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps and materials are generally not described in detail in order to avoid unnecessarily obfuscating the description of the present invention.

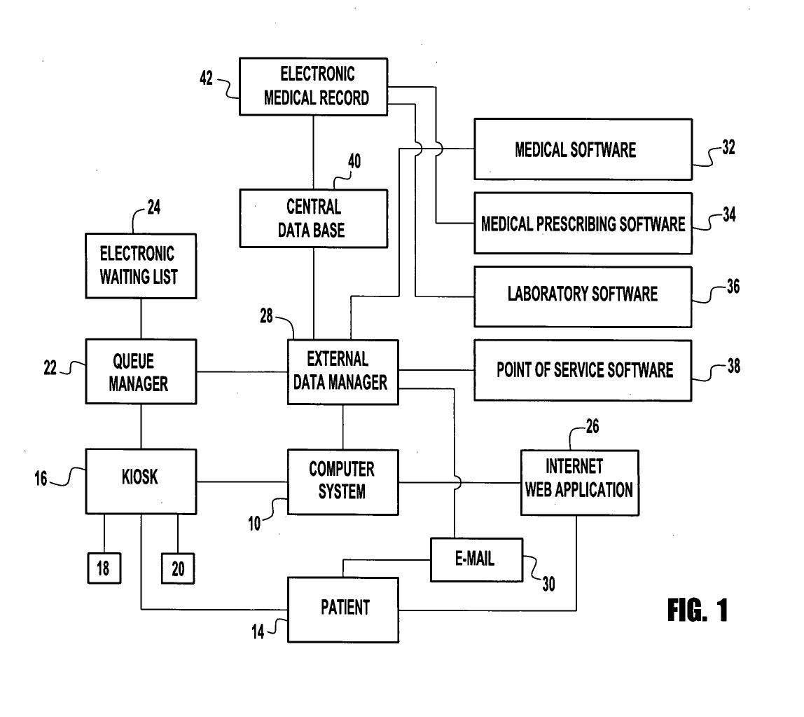

FIG. 1 illustrates a flow chart of the steps incorporated in the present invention.

Box 10 represents the computer system of the clinic. The computer system may include, without limitation, various hardware resources (e.g., servers, computer peripherals, etc.), or even software resources (e.g., application programs and the like) or any combination thereof. The synchronization of the access to the hardware resources may be done simultaneously for the software resources.

The computer system 10 is a comprehensive and integrated system which controls and coordinates all aspects of clinic functioning including but not limited to the controlling steps including: setting up appointments based on information from an interactive website; setting up appointments for walk in patients; providing information submitted by the patient to the health clinic medical provider; documenting medications prescribed and provided to patients; checking out patients from the clinic; transmitting records generated during the visit to patient's primary care provider (PCP); and controlling administrative functions. Also, the computer system 10 can have embodied thereon a program executable by a machine for controlling administrative functions of the clinic comprising but not limited to supply ordering, payroll management, bill payment, accounting, and data analysis.

ASAP Medical Software System 12 for use with the present invention is a Health Insurance Portability and Accountability Act (HIPPA) compliant client/server database application for 32 bit Windows platforms. It is designed to provide acute care health providers with a complete practice management system including electronic medical records, document archiving and routing, time and services accounting and automated local and Internet-based patient check-in. It interfaces with laboratory and medication prescribing software, such as from the Allscripts Company, therefore providing the health provider with a single point information source for all patient medical information.

The major components of the ASAP Medical Software System 12 include a Microsoft SQL Server as the core database engine. There is also the KIOSK Automated Clinic Check-in software, Internet based WEB application for remote patient check in, Patient Queue Management software, Electronic Medical Record software, an Administration utility for back-office system management, and an External Data Manager application for real-time data interface with laboratory, medications and accounting software applications and online website processes.

Box 14 represents a patient who wishes to receive medical attention from the health care provider, preferably at a health care clinic. Upon entering the health care clinic, the patient encounters a Kiosk 16.

Kiosk 16 provides one option for a patient to check-in to a health clinic such as an acute care health clinic. Kiosk 16 can be operated by a touch-screen Windows application for automated clinic check-in. Information collected by the during check-in includes demographics, payment information and presenting complaint. For new patients, a fingerprint scan can be performed at station 18, as an option, and attached to their electronic file for identification purposes. For repeat patients, a fingerprint scan, verifies the identity of the patient and all of their relevant demographic information displays for their review. A signature capture pad 20 stores the patient's signature electronically for: agreement to pay, consent to treat, and confidentiality documentation. At completion of these few steps to sign in, the patient's initials are electronically entered into the queue of waiting patients with Queue Management Software 22. Then an electronic waiting list 24 can be displayed on a display screen in the patient waiting area. Waiting list 24 can indicate how many people are ahead of the patient checking in and how long they can expect to wait to be seen. Wait times are calculated based on how many patients are waiting to be seen, how many care providers and assistants are present at the clinic, and historically, how long the care providers take on average to see a patient. Wait times are calculated for the entire clinic every 10 seconds by the Queue Management software 22.

Box 26 represents a second check-in option for a patient to check-in to a health clinic such as an acute care health clinic. The second option is an internet-based web application for remote patient check-in. This software component collects data and allows for the patient to remotely view the clinic operating status, the queue status and the wait times at the clinic in real time, to enter their demographic information, and to indicate a time that they wish to be added to the queue.

The data about the patient from the internet-based web application 26 is collected and transferred via computer system 10 to an External Data Manager (EDM) 28 in a secure fashion. The EDM 28 then analyzes the data and confirms the “appointment” in an email 30 to the patient, or notifies the patient via email of any problems with the registration so they may correct the information and resubmit.

Box 28 represents one component of the software of the present invention, i.e., an External Data Manager (EDM) Software Application. The EDM Application performs real-time data imports and exports to other major application software using interfaces designed to keep the various applications data synchronized. When a new patient checks into the clinic using either kiosk 16 or the web application 26, the EDM Application 28 exports the new patient demographic information into the electronic medical software 32, the medical prescribing software 34, the laboratory software 36 and the accounting software 38. The EDM Application 28 eliminates the need for redundant data entry and ensures the integrity of the data between applications. Moreover, when medication is prescribed for a patient, the EDM Application 28 imports that information into a Central Database 40 for incorporation in the Electronic Medical Record (EMR) 42 software application.

Box 22 represents another feature of the software that the patient may utilize, i.e., Patient Queue Management (PQM) Software. The PQM software application calculates wait times, provides an interface for clinic employees to go ‘on duty’ and ‘off duty’ so that queue times can be accurately calculated, and maintains a waiting room display of the queue so patients are aware of their wait times. It also adds remote customers to the queue.

Box 24 represents a step just prior to the time in which the patient sees a health care professional, such as a doctor, nurse, nurse practitioner, physician assistant, etc. At this time, the health care staff can locate the patient's records as well as add to them on the EMR Software Application 42. The EMR software application is a central information source for all patient data. It provides for all the addition and storage of paper documents using high-speed scanners. It provides for data entry and display to document all aspects of the clinic visit. It interfaces with laboratory software 36 and the prescribing software 34 to display a problem and medication list. It includes electronic referrals, lab test results, flow sheets, action plans and progress notes.

To locate a patient's record, the care provider accesses the queue data and selects the next patient waiting to be seen. Besides displaying the patient's records, this action also removes the patient from the queue and begins the clinical visit. At this point, all clinic queue displays will reflect the removal of a person from the queue and all remaining patient's wait times will be updated. When the patient visit is complete, the EMR produces the service invoice and any relevant insurance documentation and acts as a sales terminal to receive payment for the clinical visit.

After the patient has been seen, all of the medical information developed during the examination is uploaded into the External Data Manager (EDM) Software Application.

Then, at the end of the patient's clinical visit, the EDM Software Application exports the patient's visit and payment information into the point of service application shown as Box 38.

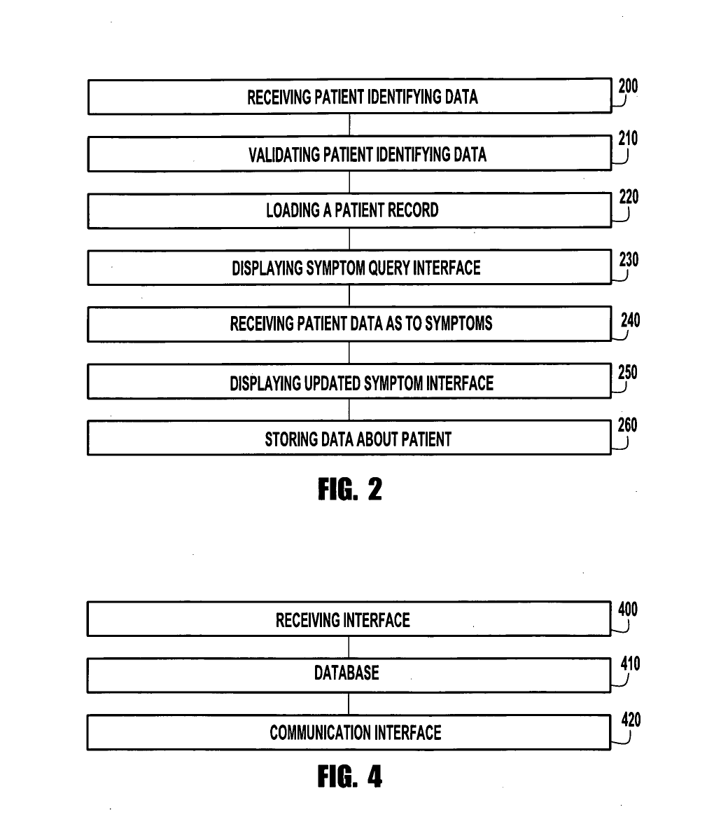

Referring to FIG. 2, there is illustrated a flow chart of the method for medical data storage. The chart includes block 200 for receiving patient identifying data. Then in block 210, the patient identifying data is validated. Next in block 220 a patient record is loaded. Continuing in block 230, a symptom query interface is displayed. Then in block 240, the patient data as to symptoms is received. Continuing in block 250, the updated symptom interface is displayed. Next in block 260, the data about patient is stored.

Referring again to FIG. 2, the step of loading a patient record 220 includes the step of searching for prior patient records and updating the patient record with any prior patient records.

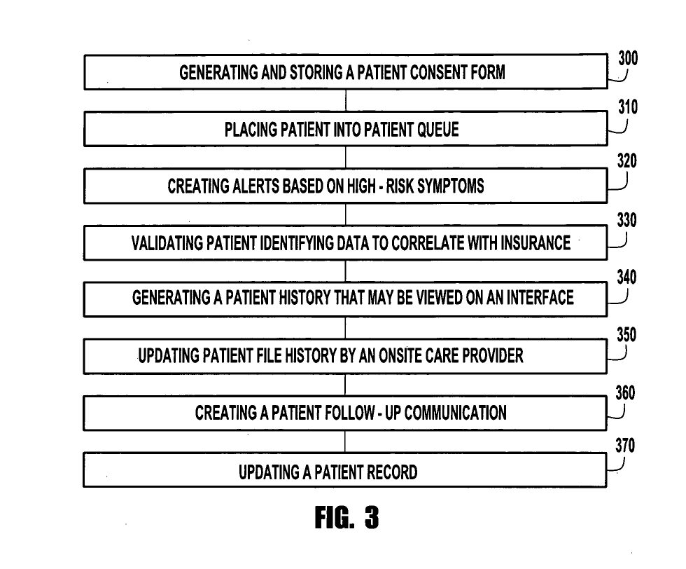

Referring to FIG. 3, there are additional steps which can be incorporated in the method for medical data storage. These include generating a patient consent form and storing the patient consent form after it has been authorized by the patient in block 300. Next, in block 310, the patient is placed into the patient queue based on patient queue criteria. Continuing in block 320, the patient is placed into the patient queue when the patient authorizes the consent form. Also, if desired, the patient is placed into patient queue based on a patient queue criteria of the high risk symptoms presented as in block 320. If desired, the method can include the step of creating alerts based on high-risk symptoms as in block 320. Also if desired, the method can include the step of validating patient identifying data to correlate with insurance as in block 330. Next, as shown in block 340, a patient history can be generated and viewed on an interface. Next, as shown in block 350, a patient file history can be updated by an onsite care provider. Then in block 360, a patient follow-up communication is created from a group consisting of ordering a lab test, generating a prescription, generating a patient instruction sheet, generating an insurance claim, generating a patient bill and accepting payment. Finally, as shown in block 370, a patient record is updated to reflect an action consisting of a filling a prescription, filing a consent, authorizing medical treatment, making payment and declining medical treatment.

As shown in FIG. 4, the present invention includes a system incorporating a box 300 of a receiving interface such as the kiosk, or internet capable of receiving patient data. Also, as shown in Box 410, there is a database capable of storing and retrieving stored patient data. Then in box, 420, there is a communication interface capable providing a communication selected from a group consisting of a prescription, a medical directive, a bill, a queue position to see a care provider.

The receiving interface 400 can include a care provider interface. The communication interface 420 can also include at least one distributed network component for communicating patient data selected from the group including a pharmacy database, an insurance company data base, A HIPPA compliant patient record database, a non-Hippa complaint patient database, a research data base, a proximate health care provider interface, a remoter health care provider interface, a searchable data base, and a redundant back-up data base.

The data base 410 can further include a device for generating reports from the group including a printer, data bases and storage discs.

Also according to the present invention, there is disclosed an article comprising a machine readable medium having embodied thereon a program. The program is executable by a machine to process patients who visit a health clinic for medical attention by performing: receiving patient identifying data; validating patient identifying data; loading a patient record; displaying symptom query interface; receiving patient data as to symptoms; displaying updated symptom interface; and storing data about patient. The article further includes placing the patients into patient queue based on patient queue criteria and searching for prior patient records and updating the patient record with any prior patient records.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for medical data storage comprising:
receiving patient identifying data;
validating patient identifying data;
loading a patient record;
displaying symptom query interface;
receiving patient data as to symptoms;
displaying updated symptom interface; and
storing data about patient.

2. The method of claim 1 wherein the step of loading a record includes the step of searching for prior patient records and updating the patient record with any prior patient records.

3. The method of claim 1 including the steps of:
generating a patient consent form; and
storing said patient consent form after it has been authorized by the patient.

4. The method of claim 1 including the steps of:
placing patient into patient queue based on patient queue criteria.

5. The method of claim 4 including the step of:
placing patient into patient queue based on a patient queue criteria of when the patient authorizes the consent form.

6. The method of claim 4 including the step of:
placing patient into patient queue based on a patient queue criteria of the symptoms presented.

7. The method of claim 4 including the step of:
placing patient into patient queue based on a patient queue criteria selected from the group of when the patient authorizes the consent form the symptoms presented.

8. The method of claim 1 including the step of:
creating alerts based on high-risk symptoms

9. The method of claim 1 including the step of:
validating patient identifying data to correlate with insurance.

10. The method of claim 1 including the step of generating a patient history that may be viewed on an interface.

11. The method of claim 10 including the step of:
updating patient file history by an onsite care provider.

12. The method of claim 1 including the step of:
creating a patient follow-up communication selected from a group consisting of ordering a lab test, generating a prescription, generating a patient instruction sheet, generating an insurance claim, generating a patient bill and accepting payment.

13. The method of claim 1 including the step of:
updating a patient record to reflect an action consisting of a filling a prescription, filing a consent, authorizing medical treatment, making payment and declining medical treatment.

14. A system for medical data storage comprising:
a receiving interface capable of receiving patent data;
a database capable of storing and retrieving stored patient data; and
a communication interface capable providing a communication selected from a group consisting of a prescription, a medical directive, a bill, a queue position to see a care provider.

15. The system of claim 14 which further includes a care provider interface.

16. The system of claim 14 which further includes least one distributed network component for communicating patient data selected from the group including a pharmacy database, an insurance company data base, A HIPPA compliant patient record database, a non-Hippa complaint patient database, a research data base, a proximate health care provider interface, a remoter health care provider interface, a searchable data base, and a redundant back-up data base.

17. The system of clam 14 which further includes a device for generating reports from the group including a printer, data bases and storage discs.

18. An article comprising a machine readable medium having embodied thereon a program, the program being executable by a machine to process patients who visit a health clinic for medical attention by performing:
receiving patient identifying data;
validating patient identifying data;
loading a patient record;
displaying symptom query interface;
receiving patient data as to symptoms;
displaying updated symptom interface; and
storing data about patient.

19. The article of claim 18 which further includes placing the patients into patient queue based on patient queue criteria.

20. The article of claim 18 which further includes searching for prior patient records and updating the patient record with any prior patient records.
